(19) United States
(12) Patent Application Publication
(10) Pub. No.: US 2005/0021195 A1
(43) Pub. Date: Jan. 27, 2005

(54) DYNAMIC OBJECT AVOIDANCE WITH AUTOMATED GUIDED VEHICLE

(75) Inventors: David W. Zeitler, Caledonia, MI (US); Matthew L. Werner, Ada, MI (US); Garry A. Koff, Grand Rapids, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: RAPISTAN SYSTEMS ADVERTISING CORP., Grand Rapids, MI (US)

(21) Appl. No.: 10/710,565

(22) Filed: Jul. 21, 2004

Related U.S. Application Data
(60) Provisional application No. 60/481,113, filed on Jul. 21, 2003.

(51) Int. Cl. G06G 7/78

(52) U.S. Cl. 701/23; 701/301; 180/167

(57) ABSTRACT

A method and apparatus for guiding an automated-guided vehicle includes providing a guide path defined with respect to a physical path and controlling a vehicle to generally follow the guide path. The presence of an obstacle at the guide path is detected, such as with a laser scanner, radar detector, or the like. The vehicle is controlled around the obstacle and back to the guide path. This may be accomplished by generating an offset to the guide path at the detected obstacle.

### CROSS REFERENCE To RELATED APPLICATIONS

The present application claims the benefit of U.S. provisional application Ser. No. 60/481,113, filed Jul. 21, 2003, for DYNAMIC OBJECT AVOIDANCE WITH AUTOMATED GUIDED VEHICLE, which is hereby incorporated herein by reference in its entity.

### BACKGROUND OF INVENTION

The present invention relates to an automated-guided vehicle (AGV) control and, in particular, to a method and apparatus for dynamically detecting objects in the path of travel of the vehicle and guiding the vehicle around the object, known as an “obstacle.”

AGV systems are used extensively today in a wide variety of material handling applications. AGVs come in a wide variety of types from those carrying cargo on their back to those that tow trains of cargo behind them on carts, to still other types. In order for each AGV to be able to automatically guide itself throughout a factory or plant, it must be able to determine its position within the factory and the orientation of the vehicle. A common system utilizes dead-reckoning navigation. An example includes incremental sensors used on the AGV including wheel encoders that measure the rotation of one or more wheels on the AGV and gyroscopes that measure change of the vehicle's orientation. Update markers, such as magnets buried in the floor, transponders positioned as known locations, and the like, correct for drift in the dead-reckoning navigation. The vehicle is controlled along a virtual guide path, namely, a guide path which is defined in a computer memory, either on the vehicle itself or at some central control. This is in contrast to a physical guide path, such as wires or active strips in the floor.

Once a virtual guide path is established, it has required programming changes in order to change the guide path. In U.S. patent application Ser. No. 10/394,546 filed Mar. 21, 2003, by Werner et al. for a GRAPHICAL SYSTEM CONFIGURATION PROGRAM FOR MATERIAL HANDLING, the layout of a virtual guide path is greatly facilitated. However, changes to the guide path still require operation of a computer both to change the guide path and to restore it to its initial condition.

### SUMMARY OF INVENTION

The present invention allows a virtual guide path to be momentarily modified in order to direct a vehicle around a particular area. This may be accomplished by positioning a temporary obstacle, such as a traffic cone, or the like, at the beginning of the area with respect to the travel of the vehicle. The system will automatically and dynamically guide the vehicle around the obstacle and return the vehicle to the guide path when the obstacle has been cleared. This may be accomplished with various types of vehicles including vehicles which tow a chain of carts in a train. This may be accomplished by producing an offset to the virtual guide path at the location of the obstacle automatically and dynamically in order to guide the vehicle through the open area adjacent the obstacle.

### BRIEF DESCRIPTION OF DRAWINGS

FIG. 1 is a top plan view of an automated-guided vehicle system, according to the invention, illustrating a vehicle diverting around an obstruction identified as an “obstruction zone”;

FIG. 2 is a flow diagram of a control system for the automated guided vehicle in FIG. 1;

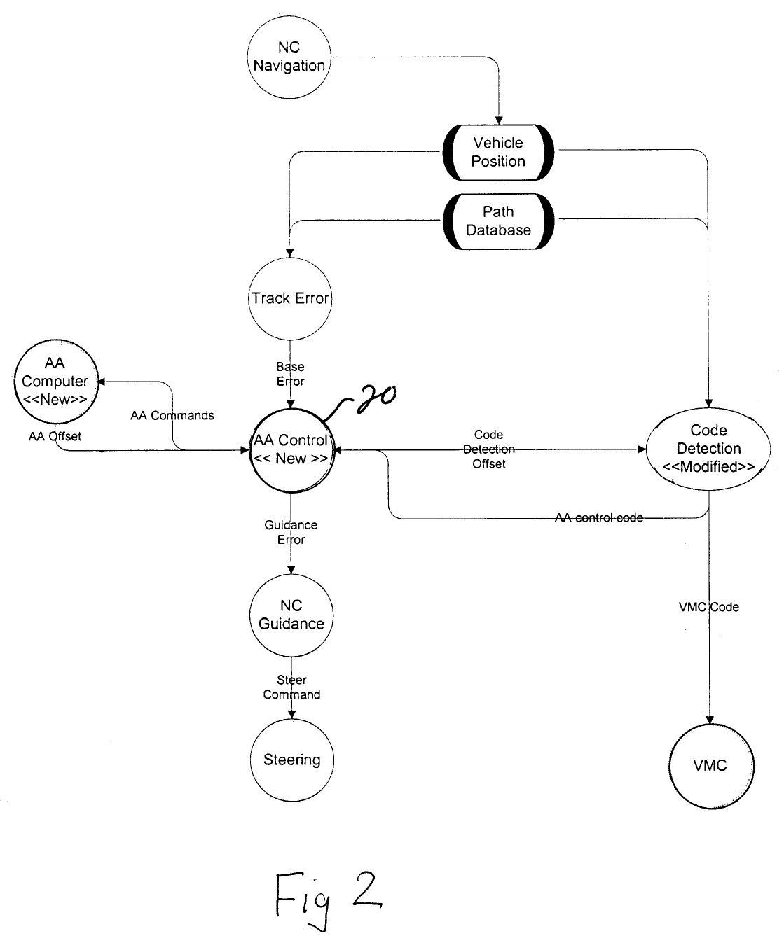

FIG. 3 is a block diagram of the control system of the vehicle in FIG. 1;

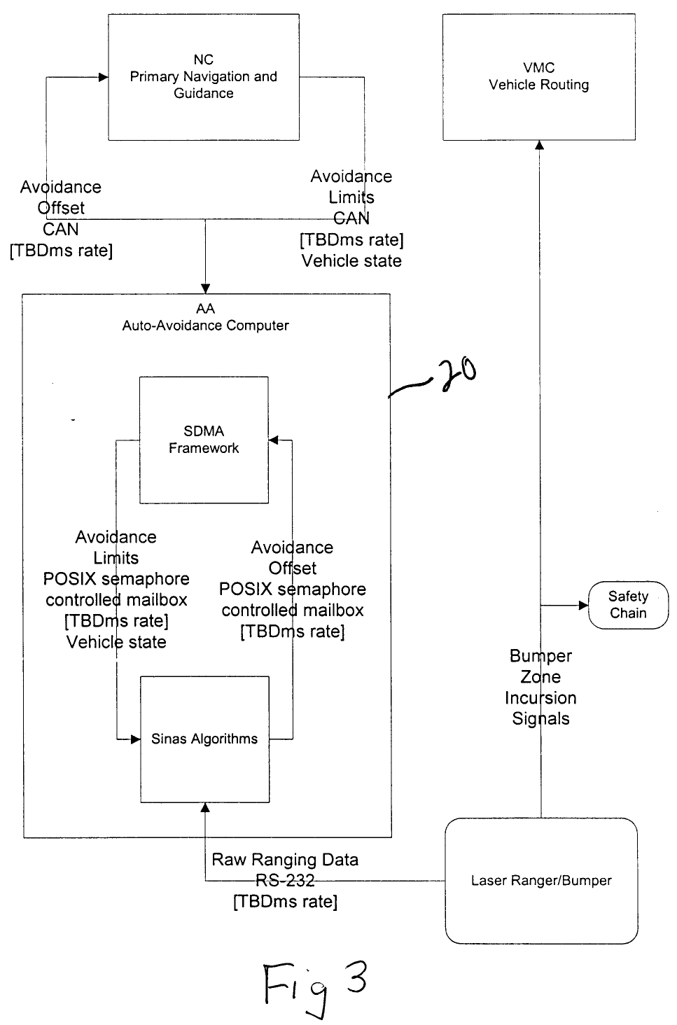

FIG. 4 is an illustration of a vehicle guiding around a simple obstruction;

FIG. 5 is a diagram illustrating an AGV guiding around a complex obstruction;

FIG. 6 is a diagram illustrating parameters used in determining guide path offset, or deviation; and

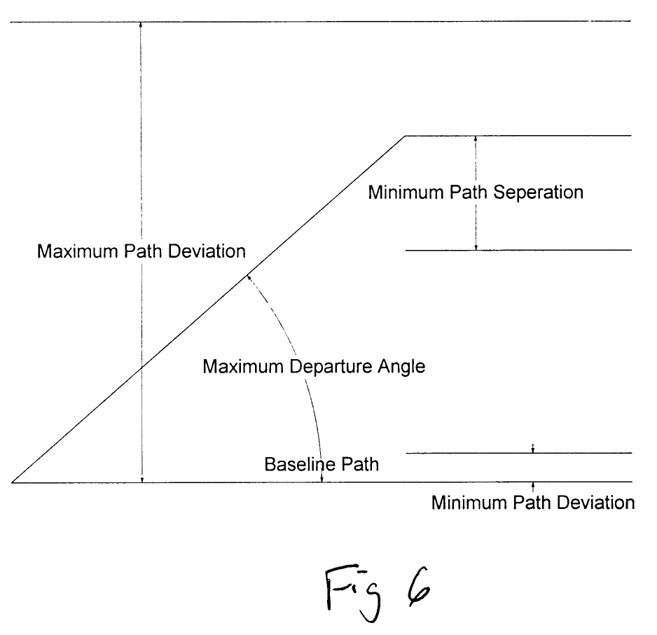

FIG. 7 is a diagram of update markers useful with the invention.

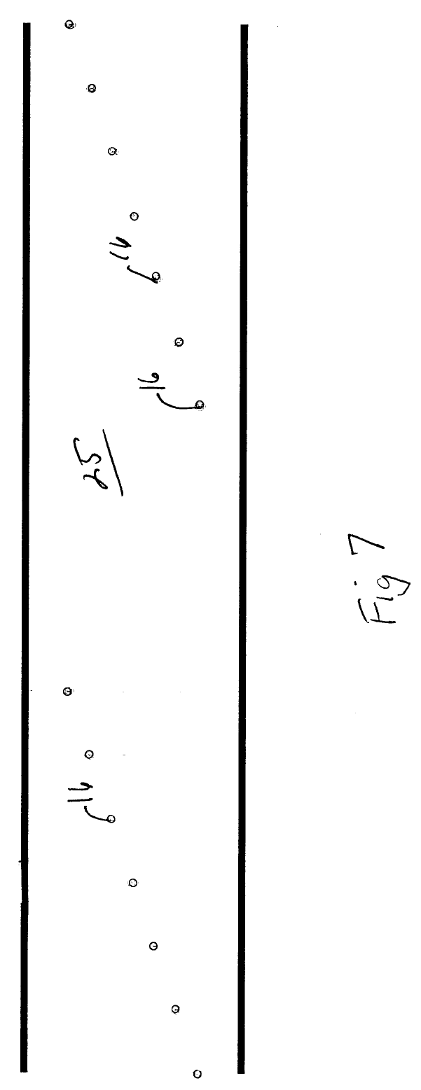

### DESCRIPTION OF THE PREFERRED EMBODIMENT

Referring now to the drawings and the illustrative embodiments depicted therein, an automated-guided vehicle system and method 10 includes one or more guided vehicles 12 which is controlled, at least in part, by a central dispatcher (not shown) which issues commands to the vehicle 12 as to its destination. In the illustrative embodiment, the vehicle autonomously travels along a guide path 14, which is a virtual guide path. The virtual guide path is defined in memory, such as in a computer on-board vehicle 12. It should be understood that the invention may be applied to other types of systems, such as systems in which a central control provides detailed steering instructions to vehicle 12. Vehicle 12 includes a navigation computer NC which provides dead-reckoning guidance to the vehicle. Such dead-reckoning systems are well known in the art and will not be described in more detail herein. Suffice it say, such dead-reckoning systems produce drift from the guide path. Therefore, they are occasionally updated by an update system such as a marker system which is illustrated in the embodiment as a plurality of stationary magnets 16 which are intercepted by and detected by a magnetic bar under vehicle 12. Such systems are well known in the art and will not be described further herein. Although illustrated as a series of magnets in the floor, other techniques may be utilized to correct for drift in the navigation system. Examples include U.S. patent application Ser. No. 10/209,766 filed Jul. 31, 2000, by Zeitler for MATERIAL HANDLING SYSTEMS WITH HIGH FREQUENCY LOCATION DEVICES, the disclosure of which is hereby incorporated herein by reference. It is also known to provide vehicle 12 with an object detection system, known as a “bumper” in order to stop the vehicle prior to colliding with a fixed obstacle. Such known systems include a scanning laser which scans in a plane or multiple planes ahead of the vehicle and detects an object in time for the vehicle to stop before colliding with the object. Other schemes are known to avoid collisions between the vehicles 12.

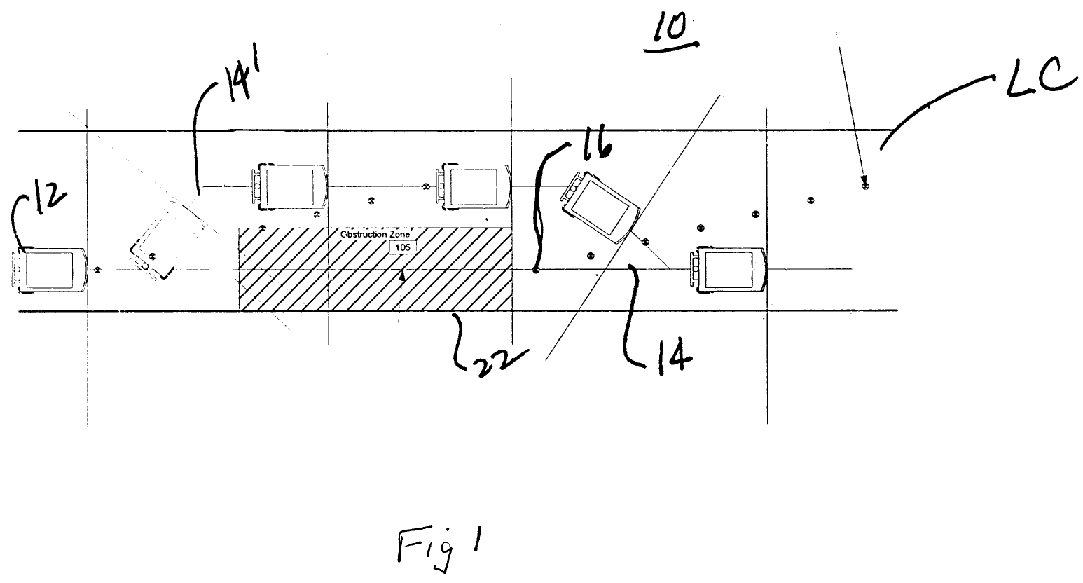

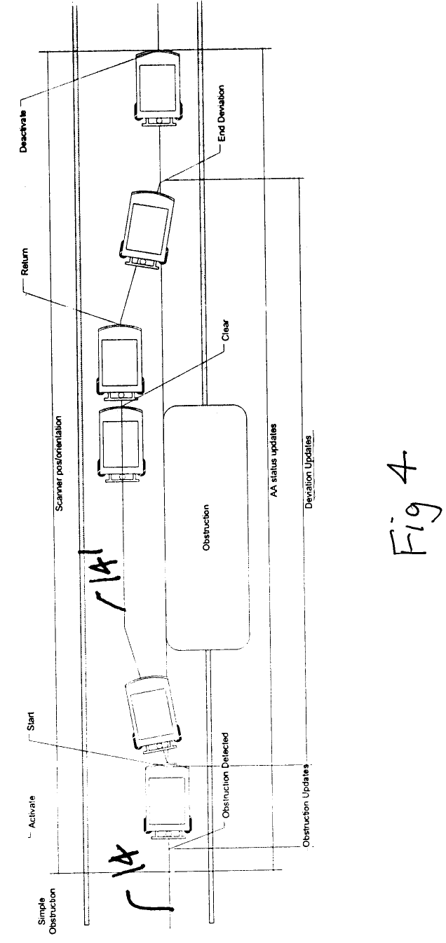

The present invention includes an auto-avoidance computer 20. Auto-avoidance computer 20 receives input from a detection device, such as a laser scanner. The laser scanner may be shared with the bumper collision avoidance system of the vehicle. However, the auto-avoidance computer, instead of stopping the vehicle, causes the vehicle to navigate around the obstacle and back to the guide path. This may be accomplished by generating an offset 14′ to guide path 14, as illustrated in FIGS. 1 and 4. This is accomplished by sensing the position of an obstacle, such as a traffic cone placed in an area of travel of the vehicle (obstruction zone) 22, and determining an area adjacent the obstruction zone in which the vehicle can travel. An offset to the guide path 14 is calculated and is designated offset 14′. When the vehicle no longer detects the cone, the auto-avoidance computer informs the navigation computer of this occurrence. The navigation computer can determine an appropriate time to return to the original guide path 14, taking into account factors such as the length of the vehicle. The length of the vehicle may be significant when the vehicle is a tugger vehicle that is tugging a train of carts, or the like. When the vehicle is being controlled along an offset guide path 14′, it may still be necessary to obtain updates to the position of the vehicle. This may be accomplished by providing a unique magnet pattern 25 in which magnets 16 are arranged off of guide path 14 as well as on and along guide path 14. By arranging magnets 16 along a diagonal, a magnet may be intercepted even while the vehicle is traveling along offset guide path 14′. Moreover, by arranging the magnets along a diagonal, the position of each magnet may be uniquely determined because it varies in both the X and Y coordinates from other magnets. Moreover, magnets may be detected off of the guide path without the necessity for providing a grid of magnets as is known in the prior art.

In the illustrative embodiment, auto-avoidance computer 20 is a Sinas algorithm module, which is marketed by Siemens Corporation for use in automated-guided vehicles, such as floor sweepers, and the like. However, in contrast to other applications for the Sinas algorithm module, the present invention utilizes virtual guide paths and offsets from virtual guide paths in order to allow the vehicle to deviate from the guide path around an obstruction zone and return to the guide path at the end of the obstruction. Moreover, the present invention envisions that the dynamic object avoidance technique may be utilized within a limited control area LC, such as a particular hallway, or the like. Within the limited control area LC, the vehicle dynamically avoids objects as previously described. When outside of the limited control area LC, the vehicle stops for obstructions to the guide path as is known in the art.

The approach is to minimize complexity and impact on known systems. This is accomplished by first limiting the scope of the automation, using manually entered control codes which enable and disable the AA mode and may also provide it with configurable limits. Secondly, the impact of the new functions are isolated by keeping them to a small change in the existing NC and using an external computer to house the new algorithms. This external computer would likely be an embedded PC running Timesys Linux with a CAN bus interface to the current NC and a serial interface to the laser (either the existing one or a second laser specifically for this purpose). Existing algorithms should easily integrate into this operating environment.

The invention is based upon the fact that the obstruction can be determined by occlusion in the plane of a single laser sweep. This is not too restrictive for the customer and greatly decreases the cost and complexity.

An onboard navigation system updates position periodically, such as every 10 ms, and can provide position and orientation periodically, such as every 50 ms to the known algorithms. Guidance calculations may be performed periodically, such as every 20 ms in most vehicles, but updates of auto avoidance offset every 50 ms should be adequate. The navigation solution may be based on dead-reckoning, such as using a gyroscope and odometry with a Kalman filter providing stabilization and sensor calibration through magnet sensor readings.

The NC has a path map represented as an arbitrarily linked network of lines and arcs with virtual code and magnet objects associated with it. It does not however have information about walls, equipment or other objects. The system can get around this problem by assuming a relatively simple ‘universal’ map for an operational aisle with obstructions and manually limit activation to these situations. The algorithms would then assume walls within view to the left and right with open floor extending forward indefinitely. Protrusions or objects on the open floor would be candidates for avoidance. Moving objects can be filtered out or other objects that should trip a bumper stop rather than an avoidance.

Functional Requirements

Vehicle Management Computer (VMC)

Laser Scanner (LS)

Navigation Computer (NC)

Auto Avoidance Computer (AA)

Framework

The existing framework of Janz CAN driver and Timesys Linux for embedded systems will be utilized. This environment has demonstrated 5 kHz discrete I/O data collection and is currently being used for high speed 1K baud CAN data collection at greater than 1000 messages/second rates from photo array sensors. It will provide a known platform to easily host the existing Sinas modules as well as future migration of NC functionality out of the existing 16 bit DOS environment into a more modern and capable platform.

Sinas Algorithm Module

This module is to be provided by the Intelligent Autonomous Systems group of the Information & Communications Division of Siemens Corporate Technology. It encapsulates existing Sinas software to handle the laser scanner(s) and determine the object avoidance path planning. The module will be treated as a black box with the following requirements.

Software

Software provided needs to be compiled for and linked into a Linux (or possibly QNX) embedded computer system on the AGV. To assure this and keep the provided software as modular as possible it should meet the following requirements:
POSIX/ANSI compliant code
Single compilation package
Initiated as a single thread with Round Robin Scheduling
Manages its own sub-threads

Functions

Functionality required initially is obstruction detection and deviation calculation. Self test and diagnostic functions may be provided.

Interfaces

The Sinas algorithms will be started as a single thread with appropriate priority. Root privilege will be present in the parent process. The software may start its own sub threads as needed. Necessary setup parameters such as the serial port identifier for the laser scanner will be provided in a argument list at thread startup. The serial port connection to the scanner will then be handled by the Sinas software. Further communication from the Sinas software to/from the NC computer will be routed through a pair of semaphore controlled mailboxes.

Interface Specifications

System Components

Vehicle Management Computer (VMC)

The VMC handles

Laser Scanner (LS)

This can be an existing Sick scanner in use as a laser bumper, or a new scanner specifically for AA use. Optionally, this may be a Siemens laser system.

Navigation Computer (NC)

Auto Avoidance Computer (AA)

This computer will provide the home for the Sinas algorithms.

Sinas Algorithm Module (SAM)

MessageS

Tags are event messages. Dimension lines cover periodic message intervals. Those to the top of the drawing are NC->AA, while the bottom side are AA->NC. Periodic messages are not shown.

Events

Event messages occur once with a positive acknowledge message returned from the receiver. Failure to acknowledge initiates a retransmit with multiple attempts before a failure condition.

Activate: NC=>SAM

Starts the SAM watching for potential obstructions and establishes the baseline path (straight line in plant frame) along with limits for deviation.

Obstruction Detect: SAM=>NC

Based on the activation parameters the SAM will report an obstruction detected and estimation of necessary deviation start point.

Start Deviation: SAM=>NC

Upon reaching the required deviation point, the SAM will note ‘Start Deviation’ and begin sending deviation updates for the NC to follow.

Cleared Obstruction: SAM=>NC

Once the zero-zero point of the scanner passes the last obstruction, a ‘Cleared Obstruction’ message will be issued from the SAM to the NC indicating it is ready to return to normal path.

Return to path Deactivate: NC=>SAM

Return to path is initiated by the NC when sufficient distance past the cleared point has been reached to assure train clearance of the obstruction. This clearance is based on the assumption that the deviation path is at minimum path separation from the obstruction.

End Deviation: SAM=>NC

Upon sending the final zero deviation update the SAM will acknowledge return to path with the ‘End Deviation’.

Deactivate: NC=>SAM

At the end of the acceptable auto avoidance zone, the SAM will be notified to ‘sleep’ until needed again by issuing a ‘Deactivate’ message.

Periodic

Periodic messages transmit at a fixed rate from source to destination. If destination fails to receive periodic transmissions after to be determined periods, a communications fault condition is flagged.

Deviation Update: SAM=>NC

From the ‘Start Deviation’ event through the ‘End deviation’ event, these are transmitted periodically from the SAM to the NC.

Orientation update: NC=>SAM

Provides scanner position and location in plant frame to the Sinas algorithms. Updates begin following the ‘Activate’ event message and are transmitted periodically thereafter until the deactivate event.

A More Complex Scenario

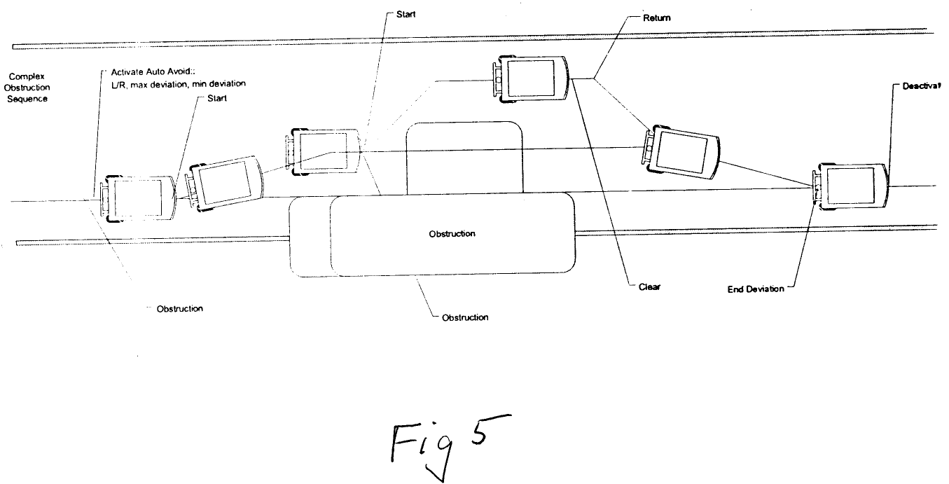

In this case, illustrated in FIG. 5, an initial obstruction is avoided, but then an extension is detected which can be maneuvered around. A second detect and start deviation message set is exchanged, allowing a maneuver around the extended obstruction. Clear is indicated only after full return to the main path can be achieved in a single maneuver.

Changes and modifications in the specifically described embodiments can be carried out without departing from the principles of the invention which is intended to be limited only by the scope of the appended claims, as interpreted according to the principles of patent law including the doctrine of equivalents.

1. A method of guiding an automated guided vehicle, comprising:
providing a guide path defined with respect to a physical path;
controlling a vehicle to generally follow said guide path;
detecting the presence of an obstacle at said guide path; and
controlling the vehicle around the obstacle and back to said guide path.

2. The method of guiding of claim 1 wherein said detecting included providing a sensor on the vehicle and detecting an obstacle with said sensor.

3. The method of guiding of claim 2 wherein said sensor comprises a scanning laser.

4. The method of guiding of claim 1 including defining a limited control area, controlling the vehicle around the obstacle when the presence of the obstacle is detected in said limited control area and stopping the vehicle when the presence of the obstacle is detected outside of said limited control area.

5. The method of guiding of claim 1 including detecting that an obstacle has been avoided and controlling the vehicle back to said guide path in response to the obstacle having been avoided.

6. The method of guiding of claim 1 wherein said vehicle is navigated by dead-reckoning navigation and wherein said guide path is a virtual guide path defined in a memory of a computer.

7. The method of guiding of claim 6 wherein said dead-reckoning navigation comprises gyroscope-based navigation.

8. The method of claim 6 including updating at least one of position and orientation of the vehicle are updated to correct for drift in said dead-reckoning navigation.

9. The method of claim 8 wherein said updating is performed by a high frequency location system.

10. The method of claim 9 wherein said high frequency location system comprises a plurality of stationary high frequency electromagnetic energy emitting and detecting beacons positioned at known locations and at least one mobile electromagnetic energy beacon positioned onboard the vehicle, said mobile beacon communicating with said plurality of stationary beacons using high frequency radio electromagnetic energy.

11. The method of claim 8 wherein said updating comprises positioning a plurality of spaced apart magnets along said guide path at known locations and detecting said magnets with a magnetic detector of said vehicle.

12. The method of claim 11 including positioning said plurality of magnets both on said guide path and off of said guide path, wherein said magnetic detector should detect a magnet when the vehicle is traveling on the guide path and when the vehicle is avoiding an obstacle.

13. The method of claim 12 wherein said magnets are arranged in diagonal patterns with respect to the guide path.

14. The method of claim 1 wherein said detecting the presence of an obstacle includes detecting unobstructed passage space adjacent the obstacle.

15. The method of claim 14 wherein said controlling the vehicle around the obstacle includes determining an offset to the guide path and controlling the vehicle along said offset.

16. The method of claim 1 wherein said controlling the vehicle around the obstacle includes determining an offset to the guide path and controlling the vehicle along said offset.
